(19) United States
(12) Patent Application Publication
(10) Pub. No.: US 2008/0094953 A1
(43) Pub. Date: Apr. 24, 2008

(54) FOCUS PULL-IN METHOD AND OPTICAL DISC DRIVE THEREOF

(75) Inventors: Young-Jae Park, Yongin-si (KR); Tatsuhiro Otsuka, Suwon-si (KR); Sung-hyun Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/746,852

(22) Filed: May 10, 2007

(30) Foreign Application Priority Data
Oct. 23, 2006 (KR) 2006-103143

(51) Int. Cl. G11B 7/09

(52) U.S. Cl. 369/44.29

(57) ABSTRACT

A focus pull-in method to perform an accurate focus pull-in operation in an optical disc drive using a holographic optical element (HOE) in consideration of a pseudo s-curve and an optical disc drive capable of performing the focus pull-in method, the method comprising checking whether a pseudo s-curve is contained in a focus error signal that is generated when an object lens of the optical disc drive is moved upwards or downwards, and, if the pseudo s-curve is contained in the focus error signal, controlling a focus pull-in operation for a disc loaded into the optical disc drive according to detection conditions for the pseudo s-curve. Accordingly, it is possible to accurately focus the data layer even during the driving of the disc that uses a wavelength that results in a low diffractive efficiency of the HOE.

### CROSS-REFERENCE TO RELATED APPLICATION

This application claims the benefit of Korean Patent Application No. 2006-103143, filed on Oct. 23, 2006, in the Korean Intellectual Property Office, the disclosure of which is incorporated herein by reference.

### BACKGROUND OF THE INVENTION

1. Field of the Invention

Aspects of the present invention relate to a focusing operation for an optical disc drive, and more particularly, to a focus pull-in method in an optical disc drive using a holographic optical element (HOE) and an optical disc drive capable of performing the focus pull-in method.

2. Description of the Related Art

An optical disc drive, also referred to as an optical data recording and/or reproducing device (recording/reproducing device), moves an object lens vertically towards a loaded disc in order to perform a focus pull-in operation on a data layer (or a writing layer) of the disc. The focus pull-in operation forms the focus of an optical spot on the data layer of the disc, which is also called a focusing operation.

In the optical disc drive, a pickup unit includes an HOE. The HOE enables the optical disc drive to be compatible with discs that use different standards. In the case of Compact Discs (CDs) using infrared-wavelength light, a source wavelength is 780 nm and the numerical aperture (NA) of an object lens is 0.45. In the case of Digital Versatile Discs (DVDs) using red-wavelength light, a source wavelength is 650 nm and the NA of an object lens is 0.60. In the case of Blu-ray Discs (BDs) using blue-wavelength light, a source wavelength is 405 nm and the NA of an object lens is 0.85. In order for the optical disc drive to be compatible with different types of discs using different standards, the HOE diffracts light emitted from a light source for each type of disc and condenses the diffracted light on the disc. Thus, the HOE is also called a compatible optical element.

However, because the source wavelength is different for each disc type, the diffractive efficiency of the HOE is different for each disc type. In the case of BDs, the diffractive efficiency of the HOE is 94%. In the case of DVDs, the diffractive efficiency of the HOE is 77%. In the case of CDs, the diffractive efficiency of the HOE is 38%. The use of a disc that results in a low diffractive efficiency of the HOE increases the quantity of light with unavailable orders of diffraction of the HOE. The light with unavailable orders of diffraction is defocused on the disc.

Accordingly, when the object lens is moved in a focusing direction, an s-curve type focus error signal according to astigmatism is generated not only on the data layer and the surface layer of the disc, but also on a virtual layer on which the light with unavailable orders of diffraction is defocused. The s-curve occurring on the virtual layer is a pseudo s-curve.

Therefore, if a pseudo s-curve that occurs when the object lens is moved upwards during an upward focus pull-in operation satisfies the detection conditions for the data layer of the disc, the focus pull-in operation is performed at the location of the occurrence of the pseudo s-curve. Accordingly, because a track error signal (TES) is not detected in the optical disc drive, the optical disc drive cannot perform recording/reproducing operations on the loaded disc.

If a pseudo s-curve that occurs when the object lens is moved upwards during a downward focus pull-in operation satisfies the detection conditions for the data layer of the disc, the object lens is moved upwards by a preset minimum distance so as to prevent a collision between the disc and the object lens. Accordingly, because an s-curve on the data layer is not detected during the downward movement of the object lens, the focus pull-in operation is performed at the occurrence location of the pseudo s-curve. Therefore, because a TES is not detected in the optical disc drive, the optical disc drive cannot perform recording/reproducing operations on the loaded disc.

### SUMMARY OF THE INVENTION

Aspects of the present invention provide a focus pull-in method to perform an accurate focus pull-in operation in an optical disc drive using a holographic optical element (HOE) in consideration of a pseudo s-curve and an optical disc drive capable of performing the focus pull-in method.

According to an aspect of the present invention, there is provided a focus pull-in method for an optical disc drive, the method including: checking whether a pseudo s-curve is contained in a focus error signal that is generated when an object lens of the optical disc drive is moved upwards or downwards; and if a pseudo s-curve is contained in the focus error signal, controlling a focus pull-in operation for a disc loaded into the optical disc drive according to detection conditions for the pseudo s-curve.

According to another aspect of the present invention, there is provided an optical disc drive including: a disc loaded into the optical disc drive; a pickup unit to emit light onto the disc and to receive light reflected by the disc; an RF amplifier to generate a focus error signal and an RF DC signal using a signal output from the pickup unit; a servo DSP (digital signal processor) to determine whether a pseudo s-curve is contained in the focus error signal according to the RF DC signal and a first predetermined level, and to control a focus pull-in operation for the disc according to detection conditions for the pseudo s-curve if the pseudo s-curve is contained in the focus error signal; and a focusing drive unit to drive the pickup unit vertically under the control of the servo DSP, wherein the first predetermined level is set according to the level of the RF DC signal with respect to a surface layer of the disc.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an optical disc drive according to an embodiment of the present invention;

FIG. 2 is a detailed block diagram of a servo error signal detector illustrated in FIG. 1;

FIGS. 3 through 5 are diagrams illustrating examples of the occurrence of a pseudo s-curve;

FIG. 6 is a flowchart illustrating a focus pull-in method according to an embodiment of the present invention;

FIG. 7 is a detailed flowchart illustrating an example of an operation of checking whether a pseudo s-curve is contained in a focus error signal (FES) illustrated in FIG. 6;

FIG. 8 is a detailed flowchart illustrating another example of an operation of checking whether a pseudo s-curve is contained in an FES illustrated in FIG. 6; and

FIG. 9 is a detailed flowchart illustrating an operation of controlling a focus pull-in on the basis of the detection conditions for a pseudo s-curve illustrated in FIG. 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

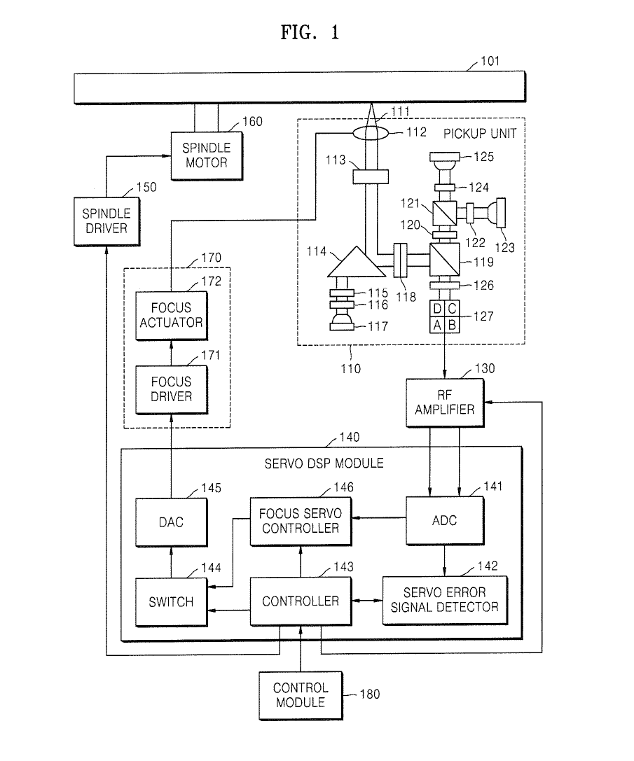

FIG. 1 is a block diagram of an optical disc drive according to an embodiment of the present invention. Referring to FIG. 1, the optical disc drive includes a disc 101, a pickup unit 110, a radio-frequency (RF) amplifier 130, a servo digital signal processor (DSP) module 140, a spindle driver 150, a spindle motor 160, a focusing drive unit 170, and a control module 180.

The disc 101 may be any disc that can record/reproduce optical data. Examples of the disc 101 are Compact Discs (CDs), Digital Versatile Discs (DVDs), Blu-ray Discs (BDs), and High Density (HD)-DVDs.

The pickup unit 110 includes an object lens 112, a holographic optical element (HOE) 113, a reflecting mirror 114, a BD/HD-DVD grating 115, a BD/HD-DVD wavelength plate 116, a BD/HD-DVD laser diode (LD) 117, a collimating lens 118, a polarization beam splitter 119, a DVD/CD compatible wavelength plate 120, a beam splitter 121, a DVD grating 122, a DVD LD 123, a CD grating 124, a CD LD 125, a condensing lens 126, and a 4-quadrant photodiode (PD) 127.

The pickup unit 110 is compatible with CDs, DVDs, BDs, and HD-DVDs. However, the pickup unit 110 may be modified to be compatible with any variety of discs. Accordingly, the pickup unit 110 can be defined to include the object lens 112, the HOE 113, a plurality of LDs based on a variety of compatible discs, and an optical system that transmits light between the LDs and the HOE 113.

When the object lens 112 is moved by the focusing drive unit 170 in the vertical direction with respect to the disc 101, the pickup unit 110 emits light (an optical beam 111) onto the disc 101 and receives (or condenses) light reflected using the 4-quadrant PD 127. Light received at the 4-quadrant PD 127 is output to the RF amplifier 130.

Using an output signal of the pickup unit 110, the RF amplifier 130 generates and outputs a focus error signal (FES) and an RF DC signal (or an RF DC servo error signal). The FES and the RF DC signal are generated during the focus search operation in which the object lens 112 is moved upwards and downwards in the vertical direction with respect to the disc 101. It is understood that the movement of the object lens 112 may not necessarily be upwards and downwards, but directions towards and away from, respectively, the disc 101. Assuming that the quadrants of the 4-quadrant PD 127 are A, B, C and D in a counterclockwise direction, the RF amplifier 130 generates the FES using an astigmatic method ((A+C)-(B+D)) for the quantity of light of each quadrant and generates the RF DC signal using the total sum (A+B+C+D; also called the “RF sum”).

On the basis of the generated RF DC signal and a predetermined level L4, the servo DSP 140 determines whether a pseudo s-curve is contained in the FES. If the pseudo s-curve is contained in the FES, the servo DSP 140 determines the detection conditions of the pseudo s-curve. On the basis of the determination results, the servo DSP 140 controls the focusing drive unit 170 to perform a focus pull-in operation for the disc 101. The predetermined level L4, which may be set to about 50% of the RF DC signal level of the surface layer, is the level of an RF DC signal that is used to detect a surface layer s-curve of the disc 101 during a Detect Disc Type (DDT) operation and the focus pull-in operation.

To this end, the servo DSP 140 includes an analog-to-digital converter (ADC) 141, a servo error signal detector 142, a controller 143, a switch 144, a digital-to-analog converter (DAC) 145, and a focus servo controller 146.

The controller 143 drives the spindle motor 160 using the spindle driver 150, thereby rotating the disc 101. The rotation of the disc 101 may be included in the DDT operation.

During the focus search operation, the controller 143 outputs a focus actuator drive signal FOD through the switch 144 and the DAC 145. In accordance with the focus actuator drive signal FOD, the focusing drive unit 170 moves the object lens 112 in the vertical direction. The focusing drive unit 170 includes a focus driver 171 and a focus actuator 172. When the focus actuator drive signal FOD is output from the servo DSP 140, the focus driver 171 drives the focus actuator 172. Accordingly, the focus actuator 172 moves the object lens 112 in the vertical direction.

When the object lens 112 is moved in the vertical direction, an FES and an RF DC signal are output from the RF amplifier 130. The ADC 141 converts the FES and the RF DC signal into digital signals. The digital FES and the digital RF DC signal are input to the servo error signal detector 142.

On the basis of the digital FES and the predetermined level L4, the servo error signal detector 142 detects the locations of the occurrence of an s-curve from the digital FES. When the object lens 12 is moved upwards or downwards, if the number of occurrence locations of the s-curve is, for example, more than 3, the servo error signal detector 142 determines that a pseudo s-curve is contained in the FES. The reason for this is that an s-curve is detected at the surface layer and the data layer of the disc 101 when the object lens 112 is moved upwards or downwards.

If it is determined that a pseudo s-curve is contained in the FES, the servo error signal detector 142 determines the detection conditions for the pseudo s-curve. The servo error signal detector 142 provides the determination results to the controller 143.

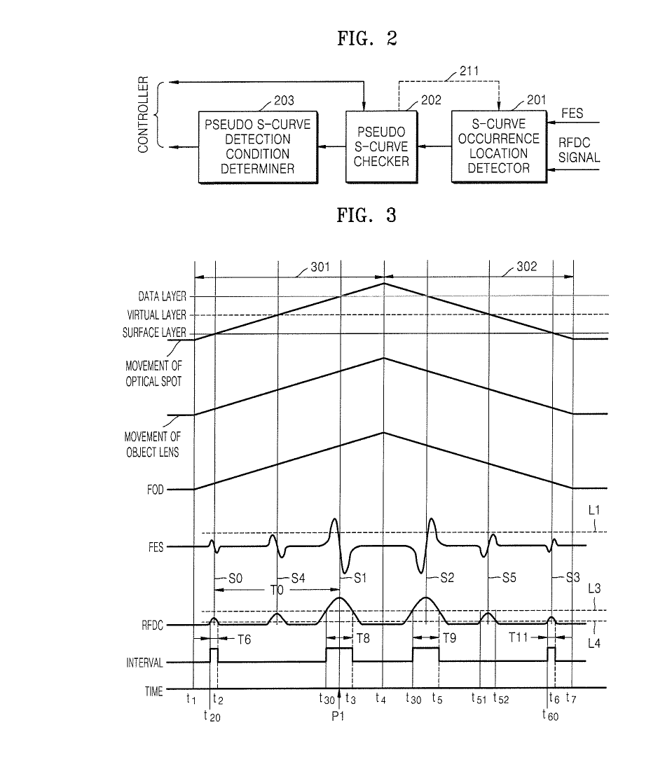

To this end, the servo error signal detector 142 may be constructed as illustrated in FIG. 2. FIG. 2 is a block diagram of the servo error signal detector 142. Referring to FIG. 2, the servo error signal detector 142 includes an s-curve occurrence location detector 201, a pseudo s-curve checker 202, and a pseudo s-curve detection condition determiner 203.

The s-curve occurrence location detector 201 monitors the level of an input RF DC signal on the basis of the predetermined level L4. If an interval where the level of the input RF DC signal is greater than the predetermined level L4 is detected, the s-curve occurrence location detector 201 detects that an FES interval corresponding to the detected interval is an interval where an s-curve occurs. The occurrence interval of the s-curve may be detected as the occurrence location of the s-curve.

On the basis of the predetermined level L4 and information about the occurrence interval of the s-curve, the s-curve occurrence location detector 201 may detect one point as the occurrence location of the s-curve.

On the basis of the number of s-curve occurrence locations detected by the s-curve occurrence location detector 201, the pseudo s-curve checker 202 checks whether a pseudo s-curve is contained in the FES. If the number of detected s-curve occurrence locations is more than 3, the pseudo s-curve checker 202 checks that a pseudo s-curve is contained in the FES. If the number of detected s-curve occurrence locations is 2, the pseudo s-curve checker 202 checks that a pseudo s-curve is not contained in the FES. The pseudo s-curve checker 202 provides the results of the checking to the pseudo s-curve detection condition determiner 203 and the controller 143.

When the results of the checking indicate that a pseudo s-curve is contained in the FES, the pseudo s-curve detection condition determiner 203 determines the pseudo s-curve detection conditions at the location where the pseudo s-curve is detected on the basis of the RF DC signal level and a predetermined level L3.

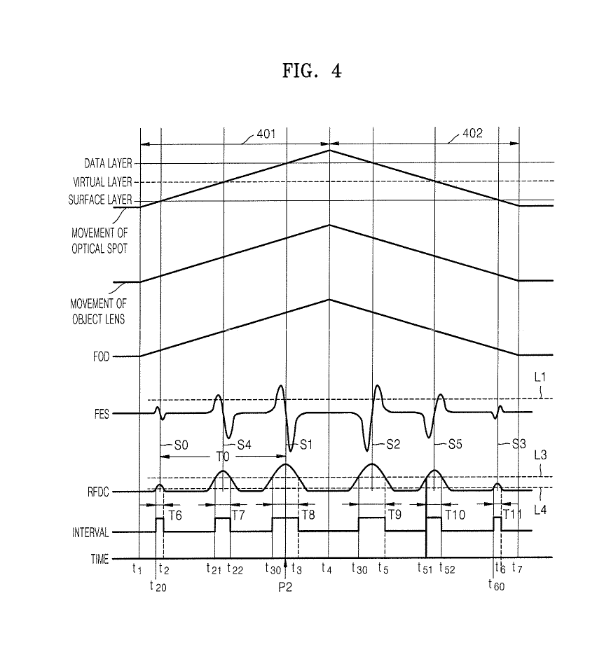

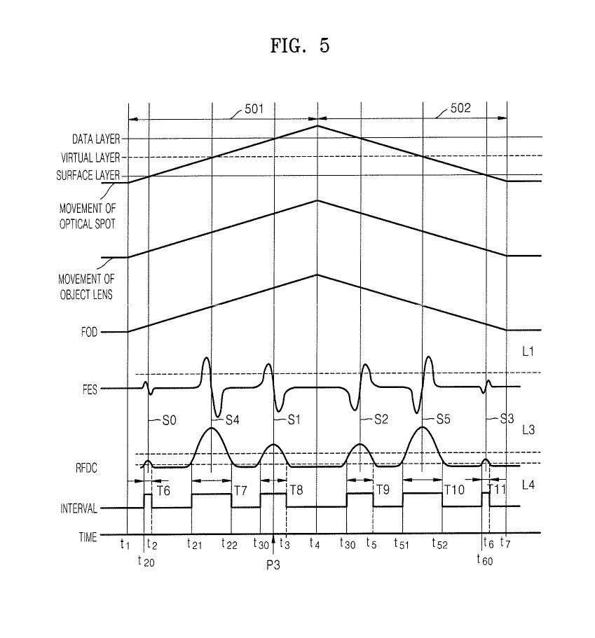

For example, the pseudo s-curve detection condition detector 203 determines the pseudo s-curve detection conditions on the basis of a first detection condition where the RF DC signal level at the pseudo s-curve detection location is smaller than the predetermined level L3 as illustrated in FIG. 3 and a second detection condition where the RF DC signal level at the pseudo s-curve detection location is equal to or greater than the predetermined level L3 as illustrated in FIGS. 4 and 5.

Referring to FIGS. 3 through 5, S0, S4 and S1 indicate the s-curve occurrence locations that are detected by the s-curve occurrence location detector 201 when the object lens 112 is moved upwards. S2, S5 and S3 indicate the s-curve occurrence locations that are detected by the s-curve occurrence location detector 201 when the object lens 112 is moved downwards. In FIGS. 3 through 5, an interval indicates a predetermined interval where an s-curve maintains a state satisfying the detection condition at the surface layer and the data layer of the disc 101. When the surface layer is detected, the predetermined interval is an interval where the s-curve is equal to or greater than the predetermined level L4. When the pseudo s-curve and the data layer are detected, the predetermined interval is an interval where the s-curve is equal to or greater than the predetermined level L3.

In FIG. 3, a reference numeral 301 denotes an interval where the object lens 112 is moved upwards and a reference numeral 302 denotes an interval where the object lens 112 is moved downwards. In FIG. 4, a reference numeral 401 denotes an interval where the object lens 112 is moved upwards and a reference numeral 402 denotes an interval where the object lens 112 is moved downwards. In FIG. 5, a reference numeral 501 denotes an interval where the object lens 112 is moved upwards and a reference numeral 502 denotes an interval where the object lens 112 is moved downwards. In FIGS. 3 through 5, a predetermined level L1 is an FES level that is to be detected as a data layer s-curve during the focus search (DDT, focus pull-in) operation, which may be set to about 50% of a data layer FES level.

The second detection condition may include a third detection condition and a fourth detection condition. In the third detection condition, an RF DC signal level at a location where a pseudo s-curve is detected is equal to or greater than the predetermined level L3 during a first time period T7, and the first time period T7 is smaller than a second time period T8, as illustrated in FIG. 4. In the fourth detection condition, an RF DC signal level at a pseudo s-curve detection location is equal to or greater than the predetermined level L3 during the first time period T7, and the first time period T7 is equal to or greater than the second time period T8, as illustrated in FIG. 5. The second time period T8 indicates a time period during which the detection condition for the RF DC signal level at the data layer of the disc 101 is satisfied as illustrated in FIGS. 4 and 5.

According to an aspect of the present invention, if the number of s-curve occurrence locations detected by the s-curve occurrence location detector 201 is 2, the pseudo s-curve checker 202 can check whether the disc 101 uses a wavelength that results in a low diffractive efficiency of the HOE of the optical disc drive on the basis of the upward-movement time T0 of the object lens 112 from the detection of an s-curve occurrence location S0 in the surface layer of the disc 101 to the detection of an s-curve occurrence location S1 in the data layer of the disc 101.

The controller 143 may have a reference value for the above checking. Accordingly, when the upward-movement time T0 is detected, the pseudo s-curve checker 202 transmits the detected upward-movement time T0 to the controller 143. The controller 143 determines the type of a corresponding disc on the basis of the received upward-movement time T0 and provides information about the determined disc type to the pseudo s-curve checker 202. On the basis of the determined disc type, the pseudo s-curve checker 202 checks whether the disc 101 uses a wavelength that results in the low diffractive efficiency.

Alternatively, the pseudo s-curve checker 202 receives information about the upward-movement time for each disc type from the controller 143 and determines a disc type corresponding to the detected upward-movement time T0 in order to check whether the disc 101 uses a wavelength that results in the low diffractive efficiency.

If the disc 101 uses a wavelength that results in the low diffractive efficiency, the pseudo s-curve checker 202 requests the controller 143 to increase the gain of a servo error signal and controls the s-curve occurrence location detector 201 via a line 211 in order to perform the s-curve occurrence location detection again.

Accordingly, the levels of the FES and the RF DC signal increase and the s-curve occurrence location detector 201 may detect more than three s-curve occurrence locations. In order to increase the gain of a servo error signal, the controller 143 controls the RF amplifier 130. In accordance with the results of the determination as to whether the disc 101 uses a wavelength that results in the low diffractive efficiency, the line 211 may be set when the pseudo s-curve checker 202 has a function of controlling the s-curve occurrence location detector 201.

If the number of s-curve occurrence locations detected by the s-curve occurrence location detector 201 is two and the disc 101 does not use a wavelength that results in the low diffractive efficiency, the pseudo s-curve checker 202 checks that a pseudo s-curve is not contained in the FES. The result of checking is provided to the controller 143.

If the number of s-curve occurrence locations is three or more and the disc 101 does not use a wavelength that results in the low diffractive efficiency, the pseudo s-curve checker 202 requests the controller 143 to decrease the gain of a servo error signal and controls the s-curve occurrence location detector 201 in order to perform the s-curve occurrence location detection again. Accordingly, the levels of the FES and the RF DC signal decrease and the s-curve occurrence location detector 201 may detect two s-curve occurrence locations.

The above operation of detecting s-curve occurrence after increasing/decreasing the gain of a servo error signal may be repeated several times.

If the pseudo s-curve detection condition is the first detection condition (illustrated in FIG. 3), the controller 143 turns on the focus servo controller 146 during the upward-movement of the object lens 112 such that the focus pull-in is made at a position P1 where the first s-curve (from among the s-curves detected in the FES) with an RF DC signal level of more than the predetermined level L3 is detected. Accordingly, the switch 144 and the DAC 145 output the output signal of the focus servo controller 146 as the focus actuator drive signal FOD. Accordingly, an optical spot 111 is focused on the data layer of the disc 101.

If the pseudo s-curve detection condition is the second detection condition (illustrated in FIGS. 4 and 5), the controller 143 turns on the focus servo controller 146 during the upward-movement of the object lens 112 so that the focus pull-in is made at a position P2 or P3 where the second s-curve (from among the s-curves detected in the FES) with an RF DC signal level of more than the predetermined level L3 is detected. Accordingly, the switch 144 and the DAC 145 output the output signal of the focus servo controller 146 as the focus actuator drive signal FOD. Accordingly, the optical spot 111 is focused on the data layer of the disc 101.

If the object lens 112 is moved downwards, the controller 142 turns on the focus servo controller 146 irrespective of the pseudo s-curve detection conditions so that the focus pull-in is made at a position where the first s-curve with an RF DC signal level of more than the predetermined level L3 is detected.

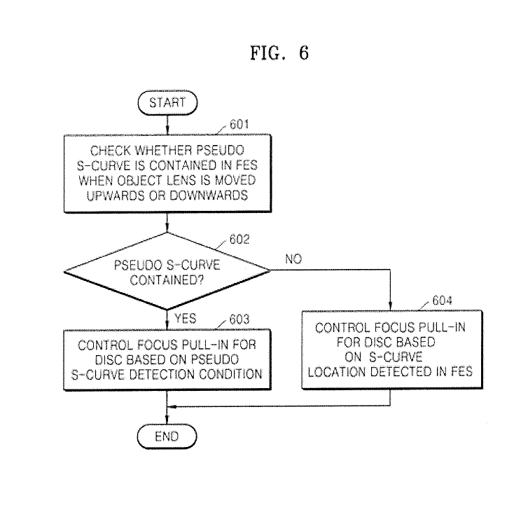

FIG. 6 is a flowchart illustrating a focus pull-in method according to an embodiment of the present invention. Referring to FIGS. 1 and 6, when the object lens 122 is moved upwards or downwards, the focus pull-in method uses the servo DSP 140 of the optical disc drive to check whether a pseudo s-curve is contained in the FES output from the RF amplifier 130 (operation 601). The above check operation may be performed in the same way as described in the s-curve occurrence location detector 201 and the pseudo s-curve checker 202 of FIG. 2.

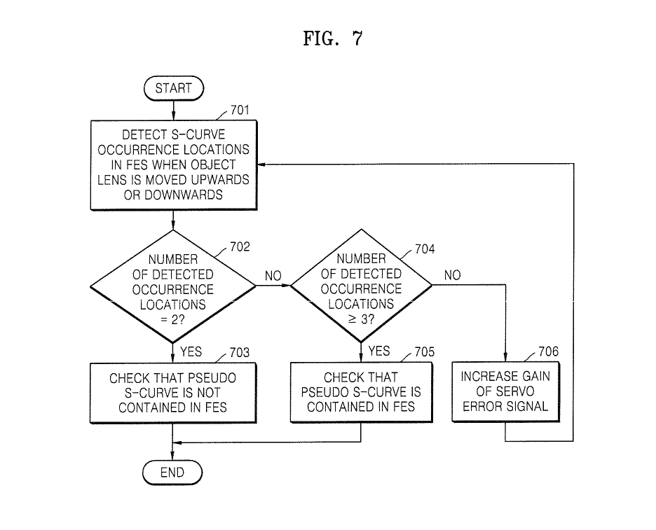

FIG. 7 is a detailed flowchart illustrating an example of an operation (operation 601 in FIG. 6) of checking whether a pseudo s-curve is contained in the FES illustrated in FIG. 6. Referring to FIG. 7, the servo DSP 140 detects the occurrence locations of an s-curve in the FES on the basis of the predetermined level L4 and the RF DC signal level that occurs when the object lens 112 is moved upwards or downwards (operation 701).

In operation 702, the servo DSP 140 checks whether the number of detected occurrence locations is two. If the number of detected occurrence locations is two, the servo DSP 140 checks that a pseudo s-curve is not contained in the FES (operation 703). If the number of detected occurrence locations is not two, the servo DSP 140 checks whether the number of detected occurrence locations is three or more (operation 704).

If the number of detected occurrence locations is three or more, the servo DSP 140 checks that a pseudo s-curve is contained in the FES (operation 705). If the number of detected occurrence locations is not three or more (operation 704), the servo DSP 140 increases the gain of a servo error signal (the FES and the RF DC signal) (operation 706) and returns to operation 701 to again detect the s-curve occurrence locations in the FES. If the number of detected occurrence locations is not two or more, the operations of FIG. 7 may be repeated several times.

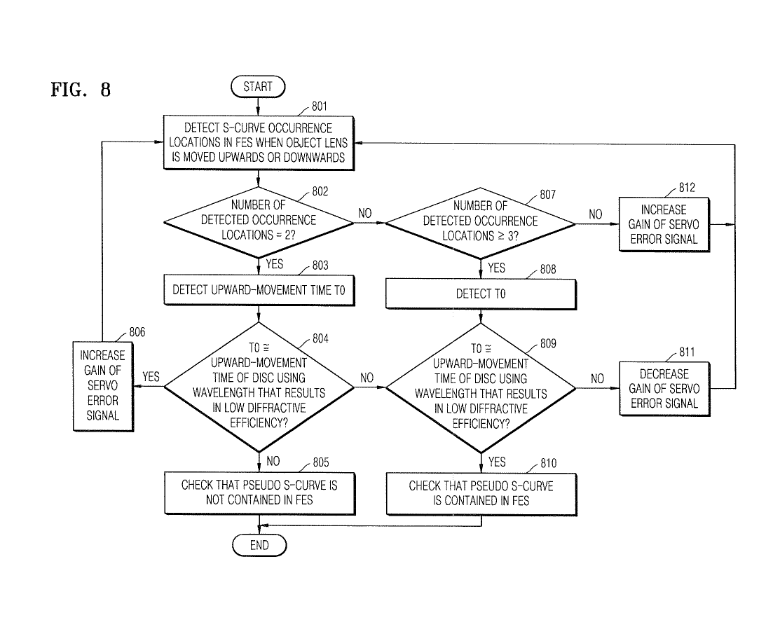

FIG. 8 is a detailed flowchart illustrating another example of an operation (operation 601 in FIG. 6) of checking whether a pseudo s-curve is contained in the FES illustrated in FIG. 6. Referring to FIG. 8, the servo DSP 140 detects the s-curve occurrence locations in the FES on the basis of the predetermined level L4 and the RF DC signal level that is generated when the object lens 112 is moved upwards or downwards (operation 801). If the number of s-curve occurrence locations is two, the servo DSP 140 detects the upward-movement time T0 of FIG. 3 (operations 802 and 803). The detection of the upward-movement time T0 may be performed in the same way as illustrated in FIG. 1.

If the detected upward-movement time T0 is similar to the upward-movement time of the disc that uses a wavelength that results in a low diffractive efficiency in the HOE, the servo DSP 140 increases the gain of a servo error signal of the optical disc drive (operations 804 and 806) and returns to operation 801 to again detect the occurrence locations in the FES. On the other hand, if the detected upward-movement time T0 is not similar to the upward-movement time of the disc that uses a wavelength that results in the low diffractive efficiency, the servo DSP 140 checks that a pseudo s-curve is not contained in the FES (operations 804 and 805).

If the number of detected occurrence locations is 3 or more, the servo DSP 140 detects the upward-movement time T0. If the detected upward-movement time T0 is similar to the upward-movement time of the disc that uses a wavelength that results in the low diffractive efficiency, the servo DSP 140 checks that the pseudo s-curve is contained in the FES (operations 807, 808, and 809). If the detected upward-movement time T0 is not similar to the upward-movement time of the disc that uses a wavelength that results in the low diffractive efficiency, the servo DSP 140 decreases the gain of a servo error signal (the FES and the RF DC signal) (operations 809 and 811) and returns to operation 801 to again detect the s-curve occurrence locations in the FES.

If the number of detected occurrence locations is not three or more (operation 807), the servo DSP 140 increases the gain of a servo error signal and returns to operation 801 to again detect the s-curve occurrence locations in the FES (operations 807 and 812).

As a result of the check results in FIG. 7 or 8, if it is determined that a pseudo s-curve is contained in the FES, the servo DSP 140 proceeds from operation 602 to operation 603 in order to control the focus pull-in operation for the disc 101 on the basis of the detection conditions for a pseudo s-curve.

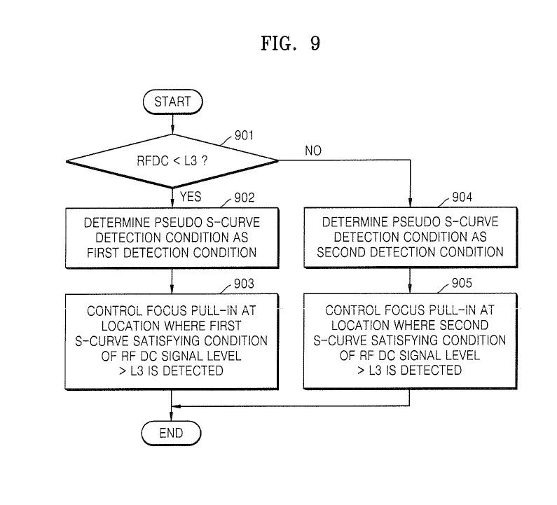

FIG. 9 is a detailed flowchart illustrating an operation (operation 603 in FIG. 6) of controlling the focus pull-in operation on the basis of the detection conditions for a pseudo s-curve illustrated in FIG. 6. Referring to FIG. 9, if the first detection condition (where the RF DC signal level at the pseudo s-curve detection location is smaller than the predetermined level L3) is satisfied, the servo DSP 140 determines that a pseudo s-curve detection condition is the first detection condition (operations 901 and 902). If a pseudo s-curve detection condition is the first detection condition, the servo DSP 140 controls a focus pull-in operation at a position where the first s-curve (from among the s-curves contained in the FES) with an RF DC signal level of more than the predetermined level L3 is detected during the upward-movement of the object lens 112 (operation 903).

If the second detection condition (where the RF DC signal level at the pseudo s-curve detection location is equal to or greater than the predetermined level L3) is satisfied, the servo DSP 140 determines that a pseudo s-curve detection condition is the second detection condition (operations 901 and 904). If a pseudo s-curve detection condition is the second detection condition, the servo DSP 140 controls a focus pull-in operation at a position where the second s-curve (from among the s-curves contained in the FES) with an RF DC signal level of more than the predetermined level L3 is detected during the upward-movement of the object lens 112 (operations 904 and 905).

The second detection condition may include the third detection condition where an RF DC signal level at a pseudo s-curve detection location is equal to or greater than the predetermined level L3 during a first time period T7 and the first time period T7 is smaller than a second time period T8; and the fourth detection condition where an RF DC signal level at a pseudo s-curve detection location is equal to or greater than the predetermined level L3 during the first time period T7 and the first time period T7 is equal to or greater than the second time period T8. The second time period T8 indicates a time period while the detection condition for the RF DC signal level at the data layer of the disc 101 loaded into the optical disc drive is satisfied.

However, when the object lens 112 is moved downwards, operation 603 of FIG. 6 may control a focus pull-in operation at a position where the first s-curve (from among the s-curves contained in the FES) with an RF DC signal level of more than the predetermined level L3 is detected.

If it is determined that a pseudo s-curve is not contained in the FES (operation 602), the servo DSP 140 controls a focus pull-in operation for the disc 101 on the basis of the detected s-curve location (operation 604). At this point, because the detected s-curve locations in the FES correspond to the surface layer and the data layer of the disc 101, the servo DSP 140 controls the focus pull-in operation at the s-curve detection location corresponding to the data layer.

Aspects of the present invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and a computer data signal embodied in a carrier wave including a compression source code segment and an encryption source code segment (such as data transmission through the Internet). The computer-readable recording medium can also be distributed over network-coupled computer systems so that the computer-readable code is stored and executed in a distributed fashion.

As described above, aspects of the present invention prevent the focus pull-in operation for the disc 101 from being performed at the pseudo s-curve occurrence location when the pseudo s-curve is generated in the optical disc drive using the HOE. Accordingly, it is possible to provide an optical disc drive that can accurately focus the data layer even during the driving of the disc 101 using a wavelength that results in low diffractive efficiency in the HOE.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A focus pull-in method for an optical disc drive, the focus pull-in method comprising:
checking whether a pseudo s-curve is contained in a focus error signal that is generated when an object lens of the optical disc drive is moved in a first direction or a second direction; and
controlling a focus pull-in operation for a disc loaded in the optical disc drive according to detection conditions for the pseudo s-curve if the pseudo s-curve is contained in the focus error signal.

2. The focus pull-in method as claimed in claim 1, wherein the checking of whether the pseudo s-curve is contained in the focus error signal comprises:
detecting occurrence locations of the pseudo s-curve in the focus error signal according to a first predetermined level and a radio-frequency direct current (RF DC) signal that is generated when the object lens is moved in the first direction or the second direction; and
checking whether the pseudo s-curve is contained in the focus error signal according to a number of the detected occurrence locations.

3. The focus pull-in method as claimed in claim 2, wherein the checking of whether the pseudo s-curve is contained in the focus error signal according to the number of the detected occurrence locations comprises:
checking that the pseudo s-curve is not contained in the focus error signal if the number of detected occurrence locations is two; and
checking that the pseudo s-curve is contained in the focus error signal if the number of detected occurrence locations is three or more.

4. The focus pull-in method as claimed in claim 3, wherein the checking of whether the pseudo s-curve is contained in the focus error signal according to the number of the detected occurrence locations further comprises:
increasing a gain of a servo error signal of the optical disc drive and again detecting the occurrence locations of the pseudo s-curve in the focus error signal if the number of detected occurrence locations is less than two.

5. The focus pull-in method as claimed in claim 2, wherein the checking of whether the pseudo s-curve is contained in the focus error signal according to the number of the detected occurrence locations comprises:
increasing a gain of a servo error signal of the optical disc drive and again detecting the occurrence locations of the pseudo s-curve in the focus error signal if the number of the detected occurrence locations is two and the disc uses a wavelength that results in a low diffractive efficiency in a holographic optical element (HOE) in the optical disc drive;
checking that the pseudo s-curve is not contained in the focus error signal if the number of the detected occurrence locations is two and the disc does not use the wavelength that results in the low diffractive efficiency;
checking that the pseudo s-curve is contained in the focus error signal if the number of the detected occurrence locations is three or more and the disc uses the wavelength that results in the low diffractive efficiency; and
decreasing the gain of the servo error signal and again detecting the occurrence locations of the pseudo s-curve in the focus error signal if the number of detected occurrence locations is three or more and if the disc does not use the wavelength that results in the low diffractive efficiency.

6. The focus pull-in method as claimed in claim 1, wherein the controlling of the focus pull-in operation comprises:
controlling the focus pull-in operation at a first position if a first detection condition is satisfied; and
controlling the focus pull-in operation at a second position if a second detection condition is satisfied.

7. The focus pull-in method as claimed in claim 6, wherein the controlling of the focus pull-in operation at the first position comprises:
controlling the focus pull-in operation at the first position where a first pseudo s-curve with an RF DC signal level of more than a second predetermined level, from among pseudo s-curves contained in the focus error signal, is detected during a movement of the object lens in the first direction if the first detection condition where the RF DC signal level at a pseudo s-curve detection location is smaller than the second predetermined level is satisfied.

8. The focus pull-in method as claimed in claim 7, wherein the controlling of the focus pull-in operation at the second position comprises:
controlling the focus pull-in operation at the second position where a second pseudo s-curve with the RF DC signal level of more than the second predetermined level, from among the pseudo s-curves contained in the focus error signal, is detected during the movement of the object lens in the first direction if the second detection condition where the RF DC signal level at the pseudo s-curve detection location is equal to or greater than the second predetermined level is satisfied.

9. The focus pull-in method as claimed in claim 8, wherein the second detection condition comprises:
a third detection condition where the RF DC signal level at the pseudo s-curve detection location is equal to or greater than the second predetermined level during a first time period and the first time period is smaller than a second time period; and
a fourth detection condition where the RF DC signal level at the pseudo s-curve detection location is equal to or greater than the second predetermined level during the first time period and the first time period is equal to or greater than the second time period,
wherein the second time period is a time period during which the detection condition for the RF DC signal level at a data layer of the disc loaded into the optical disc drive is satisfied.

10. The focus pull-in method as claimed in claim 5, wherein the checking of whether pseudo s-curve is contained in the focus error signal according to the number of the detected occurrence locations further comprises:
detecting a movement time in the first direction of the object lens from a detection of the occurrence location in a surface layer of the disc to a detection of the occurrence location in a data layer of the disc; and
comparing the movement time to a movement time in the first direction of the object lens relative to a predetermined disc that uses the wavelength that results in the low diffractive efficiency to determine if the disc uses the wavelength that results in the low diffractive efficiency.

11. The focus pull-in method as claimed in claim 1, wherein the first direction is an upwards direction and the second direction is a downwards direction.

12. The focus pull-in method as claimed in claim 1, further comprising:
controlling the focus pull-in operation for the disc according to occurrence locations of s-curves in the focus error signal if the pseudo s-curve is not contained in the focus error signal.

13. An optical disc drive comprising:
a disc loaded into the optical disc drive;
a pickup unit to emit light onto the disc and to receive light reflected by the disc;
an RF amplifier to generate a focus error signal and an RF DC signal using a signal output from the pickup unit;
a servo digital signal processor to determine whether a pseudo s-curve is contained in the focus error signal, and to control a focus pull-in operation for the disc according to detection conditions for the pseudo s-curve if the pseudo s-curve is contained in the focus error signal; and
a focusing drive unit to drive the pickup unit vertically under a control of the servo digital signal processor.

14. The optical disc drive as claimed in claim 13, wherein the servo digital signal processor comprises:
a servo error signal detector to determine whether the pseudo s-curve is contained in the focus error signal according to the RF DC signal and a first predetermined level when an object lens in the pickup unit is moved in a first direction or in a second direction, and to determine the detection conditions for the pseudo s-curve if the pseudo s-curve is contained in the focus error signal; and
a controller to control the focus pull-in operation according to the determined detection conditions received from the servo error signal detector,
wherein the first predetermined level is set according to a level of the RF DC signal with respect to a surface layer of the disc.

15. The optical disc drive as claimed in claim 14, wherein the servo error signal detector comprises:
an s-curve occurrence location detector to detect occurrence locations of the pseudo s-curve in the focus error signal according to the RF DC signal and the first predetermined level;
a pseudo s-curve checker to check whether the pseudo s-curve is contained in the focus error signal according to a number of the detected occurrence locations; and
a pseudo s-curve detection condition determiner to determine the detection conditions for the pseudo s-curve if the pseudo s-curve is contained in the focus error signal.

16. The optical disc drive as claimed in claim 15, wherein the pseudo s-curve checker checks that the pseudo s-curve is contained in the focus error signal if the number of the detected occurrence locations is three or more.

17. The optical disc drive as claimed in claim 15, wherein the pseudo s-curve checker checks that the pseudo s-curve is not contained in the focus error signal if the number of the detected occurrence locations is two.

18. The optical disc drive as claimed in claim 16, wherein the pseudo s-curve checker requests the controller to increase a gain of a servo error signal of the optical disc drive and controls the s-curve occurrence location detector to detect the occurrence locations of the pseudo s-curve in the focus error signal again if the number of the detected occurrence locations is less than two.

19. The optical disc drive as claimed in claim 15, wherein:
the pseudo s-curve checker requests the controller to increase a gain of a servo error signal of the optical disc drive and controls the s-curve occurrence location detector to detect the occurrence locations of the pseudo s-curve in the focus error signal again if the number of the detected occurrence locations is two and if the disc uses a wavelength that results in a low diffractive efficiency of an HOE in the optical disc drive; and
the pseudo s-curve checker requests the controller to decrease the gain of the servo error signal and controls the s-curve occurrence location detector to detect the occurrence locations of the pseudo s-curve in the focus error signal again if the number of the detected occurrence locations is three or more and if the disc does not use the wavelength that results in the low diffractive efficiency.

20. The optical disc drive as claimed in claim 19, wherein:
the pseudo s-curve checker checks that the pseudo s-curve is contained in the focus error signal if the number of the detected occurrence locations is three or more and the disc uses the wavelength that results in the low diffractive efficiency; and the pseudo s-curve checker checks that the pseudo s-curve is not contained in the focus error signal if the number of the detected occurrence locations is two and the disc does not use the wavelength that results in the low diffractive efficiency.

21. The optical disc drive as claimed in claim 19, wherein:
the servo DSP detects a movement time in the first direction of the object lens from a detection of the occurrence location in the surface layer of the disc to a detection of the occurrence location in a data layer of the disc; and
the controller compares the movement time to a movement time in the first direction of the object lens relative to a predetermined disc that uses the wavelength that results in the low diffractive efficiency to determine if the disc uses the wavelength that results in the low diffractive efficiency.

22. The optical disc drive as claimed in claim 13, wherein the servo DSP determines the detection conditions for the pseudo s-curve according to a first detection condition where an RF DC signal level at a pseudo s-curve detection location is smaller than a second predetermined level and a second detection condition where the RF DC signal level at the pseudo s-curve detection location is equal to or greater than the second predetermined level.

23. The optical disc drive as claimed in claim 22, wherein the second detection condition comprises:
a third detection condition where the RF DC signal level at the pseudo s-curve detection location is equal to or greater than the second predetermined level during a first time period and the first time period is smaller than a second time period T8; and
a fourth detection condition where the RF DC signal level at the pseudo s-curve detection location is equal to or greater than the second predetermined level during the first time period and the first time period is equal to or greater than the second time period,
wherein the second time period is a time period during which the detection condition for the RF DC signal level at a data layer of the disc is satisfied.

24. The optical disc drive as claimed in claim 22, wherein:
the servo DSP controls the focus pull-in operation at a first position where a first pseudo s-curve with an RF DC signal level of more than the second predetermined level, from among pseudo s-curves contained in the focus error signal, is detected during a movement of the object lens in a first direction if the pseudo s-curve detection condition is the first detection condition; and
the servo DSP controls the focus pull-in operation at a second position where a second pseudo s-curve with the RF DC signal level of more than the second predetermined level, from among the pseudo s-curves contained in the focus error signal, is detected during the movement of the object lens in the first direction if the pseudo s-curve detection condition is the second detection condition.

25. The optical disc drive as claimed in claim 14, wherein the first direction is an upwards direction and the second direction is a downwards direction.

26. A focus pull-in method for an optical disc drive, the focus pull-in method comprising:
controlling a focus pull-in operation for a disc loaded in the optical disc drive according to detection conditions for a pseudo s-curve if the pseudo s-curve is contained in a focus error signal that is generated when an object lens of the optical disc drive is moved in a first direction or a second direction.

27. The focus pull-in method as claimed in claim 26, further comprising:
checking whether the pseudo s-curve is contained in the focus error signal.

28. The focus pull-in method as claimed in claim 27, wherein the checking of whether the pseudo s-curve is contained in the focus error signal comprises:
detecting occurrence locations of the pseudo s-curve in the focus error signal according to a first predetermined level and a radio-frequency direct current (RF DC) signal that is generated when the object lens is moved in the first direction or the second direction; and
checking whether the pseudo s-curve is contained in the focus error signal according to a number of the detected occurrence locations.

29. The focus pull-in method as claimed in claim 28, wherein the checking of whether the pseudo s-curve is contained in the focus error signal according to the number of the detected occurrence locations comprises:
checking that the pseudo s-curve is not contained in the focus error signal if the number of detected occurrence locations is two; and
checking that the pseudo s-curve is contained in the focus error signal if the number of detected occurrence locations is three or more.

30. The focus pull-in method as claimed in claim 29, wherein the checking of whether the pseudo s-curve is contained in the focus error signal according to the number of the detected occurrence locations further comprises:
increasing a gain of a servo error signal of the optical disc drive and again detecting the occurrence locations of the pseudo s-curve in the focus error signal if the number of detected occurrence locations is less than two.

31. The focus pull-in method as claimed in claim 28, wherein the checking of whether the pseudo s-curve is contained in the focus error signal according to the number of the detected occurrence locations comprises:
increasing a gain of a servo error signal of the optical disc drive and again detecting the occurrence locations of the pseudo s-curve in the focus error signal if the number of the detected occurrence locations is two and the disc uses a wavelength that results in a low diffractive efficiency in a holographic optical element (HOE) in the optical disc drive;
checking that the pseudo s-curve is not contained in the focus error signal if the number of the detected occurrence locations is two and the disc does not use the wavelength that results in the low diffractive efficiency;
checking that the pseudo s-curve is contained in the focus error signal if the number of the detected occurrence locations is three or more and the disc uses the wavelength that results in the low diffractive efficiency; and
decreasing the gain of the servo error signal and again detecting the occurrence locations of the pseudo s-curve in the focus error signal if the number of detected occurrence locations is three or more and if the disc does not use the wavelength that results in the low diffractive efficiency.

32. The focus pull-in method as claimed in claim 26, wherein the controlling of the focus pull-in operation comprises:
controlling the focus pull-in operation at a first position if a first detection condition is satisfied; and
controlling the focus pull-in operation at a second position if a second detection condition is satisfied.

33. The focus pull-in method as claimed in claim 32, wherein the controlling of the focus pull-in operation at the first position comprises:
controlling the focus pull-in operation at the first position where a first pseudo s-curve with an RF DC signal level of more than a second predetermined level, from among pseudo s-curves contained in the focus error signal, is detected during a movement of the object lens in the first direction if the first detection condition where the RF DC signal level at a pseudo s-curve detection location is smaller than the second predetermined level is satisfied.

34. The focus pull-in method as claimed in claim 33, wherein the controlling of the focus pull-in operation at the second position comprises:
controlling the focus pull-in operation at the second position where a second pseudo s-curve with the RF DC signal level of more than the second predetermined level, from among the pseudo s-curves contained in the focus error signal, is detected during the movement of the object lens in the first direction if the second detection condition where the RF DC signal level at the pseudo s-curve detection location is equal to or greater than the second predetermined level is satisfied.

35. The focus pull-in method as claimed in claim 34, wherein the second detection condition comprises:
a third detection condition where the RF DC signal level at the pseudo s-curve detection location is equal to or greater than the second predetermined level during a first time period and the first time period is smaller than a second time period; and
a fourth detection condition where the RF DC signal level at the pseudo s-curve detection location is equal to or greater than the second predetermined level during the first time period and the first time period is equal to or greater than the second time period,
wherein the second time period is a time period during which the detection condition for the RF DC signal level at a data layer of the disc loaded into the optical disc drive is satisfied.

36. The focus pull-in method as claimed in claim 31, wherein the checking of whether pseudo s-curve is contained in the focus error signal according to the number of the detected occurrence locations further comprises:
detecting a movement time in the first direction of the object lens from a detection of the occurrence location in a surface layer of the disc to a detection of the occurrence location in a data layer of the disc; and
comparing the movement time to a movement time in the first direction of the object lens relative to a predetermined disc that uses the wavelength that results in the low diffractive efficiency to determine if the disc uses the wavelength that results in the low diffractive efficiency.

37. The focus pull-in method as claimed in claim 26, wherein the first direction is an upwards direction and the second direction is a downwards direction.

38. The focus pull-in method as claimed in claim 26, further comprising:
controlling the focus pull-in operation for the disc according to occurrence locations of s-curves in the focus error signal if the pseudo s-curve is not contained in the focus error signal.
